(19) United States
(12) Patent Application Publication
(10) Pub. No.: US 2014/0368557 A1
(43) Pub. Date: Dec. 18, 2014

(54) CONTENT AWARE IMAGE ADJUSTMENT TO REDUCE CURRENT LOAD ON OLED DISPLAYS

(71) Applicant: SAMSUNG DISPLAY CO., LTD., Yongin-City (KR)

(72) Inventor: Behnam Bastani, San Jose, CA (US)

(73) Assignee: SAMSUNG DISPLAY CO., LTD., Yongin-City (KR)

(21) Appl. No.: 14/297,539

(22) Filed: Jun. 5, 2014

Related U.S. Application Data
(60) Provisional application No. 61/834,543, filed on Jun. 13, 2013.

(51) Int. Cl. G09G 3/32

(52) U.S. Cl. CPC G09G 3/3283; G09G 2320/0673; G09G 2320/0626; G09G 2320/0613
USPC 345/690; 345/211

(57) ABSTRACT

A system for adjusting image content of an image to be displayed includes: a processor; and a memory, and the memory stores instructions that, when executed by the processor, cause the processor to: evaluate the image; calculate a current load amount for displaying the image; compare the current load amount with a current threshold of the system; and adjust or not adjust the image content of the image in response to the comparison. The image content is adjusted by selecting a dynamic range for rendering the image content.

### CROSS-REFERENCE TO RELATED APPLICATION

This utility patent application claims priority to and the benefit of U.S. Provisional Patent Application Ser. No. 61/834,543; filed Jun. 13, 2013, entitled “Content Aware Image Adjustment to Reduce Current Load on OLED Displays,” the entire content of which is incorporated herein by reference.

### FIELD

Embodiments of the present invention relate generally to a system for adjusting image content of an image to be displayed and a method of adjusting image content of an image to be displayed.

### BACKGROUND

Image capture technology can capture a broad dynamic range of luminance in images. However, some display devices may not be able to display such a broad dynamic range. For example, current-driven displays, including organic light-emitting diode (OLED) displays, have a range of current (e.g., a threshold) or lower/upper limits over which they are configured to operate. If too many pixels of an OLED display have bright content, an adjustment may be made to the input image to prevent the overall current from exceeding a threshold level. For example, if the screen content is black text on a white background, some adjustment may be utilized to avoid exceeding the display's maximum current threshold.

When an input image (or an input image frame) has a high overall average picture level (or brightness level), a display system may either adjust the image content or reduce the overall image brightness. Some adjustment processes apply an overall reduction in image brightness in order to meet (or avoid exceeding) the system current threshold. However, such an approach may cause a shift in the color (e.g., intended color) reproduced because the red, green, and blue (RGB) channels of the display may be changed independently according to a global ratio. This may result in a shift of the hue (e.g., desired hue) of the output image. Additionally, a global reduction to the RGB value may cause image feature loss (i.e., a loss in image detail). For instance, pixels that correspond to (or represent) edges may need to be adjusted by a different ratio than pixels in non-edge (e.g., smooth) regions in order to preserve image features (e.g., important image features) such as edges.

Also, adjustment processes that apply a pixel-by-pixel (or pixel-wise) correction so as not to exceed the maximum current load threshold may cause color shift and/or loss of image detail, because such processes operate on each pixel independently without considering the relationship between pixels (e.g., the relationship between neighboring pixels).

One approach to tone rendering of an image is detailed in Kuang, J., Johnson, G., Fairchild, M., iCAM06: A refined image appearance model for HDR image rendering, J. Vis. Commun. Image R. 18 (2007) 406-414, the entire content of which is incorporated herein by reference.

FIG. 1 is a flow diagram of a tone reproduction process according to a similar approach. The flow diagram in FIG. 1 depicts a tone reproduction process for mapping luminance and color of an input image that has a relatively high dynamic range to luminance of a display, which may only be capable of producing an image with a lower dynamic range. In the process of FIG. 1, each pixel may be assessed independently. The process preserves image features (e.g., perceptually important image features) by applying adaptive spatial filters to the input image (or input image frame). The spatial filters are adapted based on viewing and ambient conditions. In addition, a global linear adaption to the ambient and background content is considered in the rendering pipeline.

Such approaches generally involve an iterative process that repeatedly measures the difference between two images before rendering the image for display. For example, during the iterative process, pixel values (e.g., currents utilized to display the pixels) are adjusted and then compared against the system threshold levels of the display. If the adjusted pixel values do not meet the system threshold levels, the pixels may again be adjusted and again compared with the system threshold levels until the threshold levels are met. However, iterative processes can be slow and inefficient. Thus, it is desirable to reduce the iterative operation to provide faster image rendering while preserving colors and other image features as accurately as possible, all while not exceeding the threshold levels (e.g., power or current threshold levels) of the display.

### SUMMARY

According to an aspect of embodiments of the present invention, a system for adjusting image content of an image to be displayed and a method of adjusting image content of an image to be displayed adjust an input image to meet (or avoid exceeding) a display system's threshold levels (e.g., a defined power threshold) while improving preservation of image content and color hue angle.

According to an embodiment of the present invention, a system for adjusting image content of an image to be displayed includes: a processor; and a memory, and the memory stores instructions that, when executed by the processor, cause the processor to: evaluate the image; calculate a current load amount for displaying the image; compare the current load amount with a current threshold of the system; and adjust or not adjust the image content of the image in response to the comparison. The image content is adjusted by selecting a dynamic range for rendering the image content.

The image content may be adjusted when the current load amount exceeds the current threshold.

The image may be evaluated by determining an image type of the image.

The instructions, when executed, may further cause the processor to create an image brightness histogram corresponding to the image.

The current load amount may be calculated utilizing a gamma value of the image and a color lookup table.

The dynamic range for rendering the image content may be selected from a lookup table.

The lookup table may be indexed by at least one of a ratio of the current threshold to the current load amount, an image type of the image, or image brightness information of the image.

The lookup table may be generated utilizing a database including a plurality of sample images.

Inputs to the lookup table for each sample image may include image type information of the sample image and a ratio of the current threshold to a current load amount for displaying the sample image.

According to another embodiment of the present invention, a method of adjusting image content of an image to be displayed on a display system includes: evaluating, by one or more processors, the image; calculating, by the one or more processors, a current load amount for displaying the image; comparing, by the one or more processors, the current load amount with a current threshold of the display system; and adjusting or not adjusting, by the one or more processors, the image content of the image in response to the comparison. The image content is adjusted by selecting a dynamic range for rendering the image content.

The image content may be adjusted when the current load amount exceeds the current threshold.

The evaluating the image may include determining an image type of the image.

The method may further include creating, by the one or more processors, an image brightness histogram corresponding to the image.

The calculating the current load amount may include utilizing a gamma value of the image and a color lookup table.

The adjusting the image content may include selecting the dynamic range for rendering the image content from a lookup table.

The lookup table may be indexed by at least one of a ratio of the current threshold to the current load amount, an image type of the image, or image brightness information of the image.

The lookup table may be generated utilizing a database including a plurality of sample images.

Inputs to the lookup table for each sample image may include image type information of the sample image and a ratio of the current threshold to a current load amount for displaying the sample image.

### BRIEF DESCRIPTION OF THE DRAWINGS

These and other features and aspects of the present invention will be better understood by reference to the following detailed description when considered in conjunction with the accompanying drawings, briefly described below.

The patent or application file contains at least one drawing executed in color. Copies of the patent or patent application publication with color drawing(s) will be provided by the Office upon request and payment of the necessary fee.

FIG. 1 is a flow diagram of a tone reproduction process.

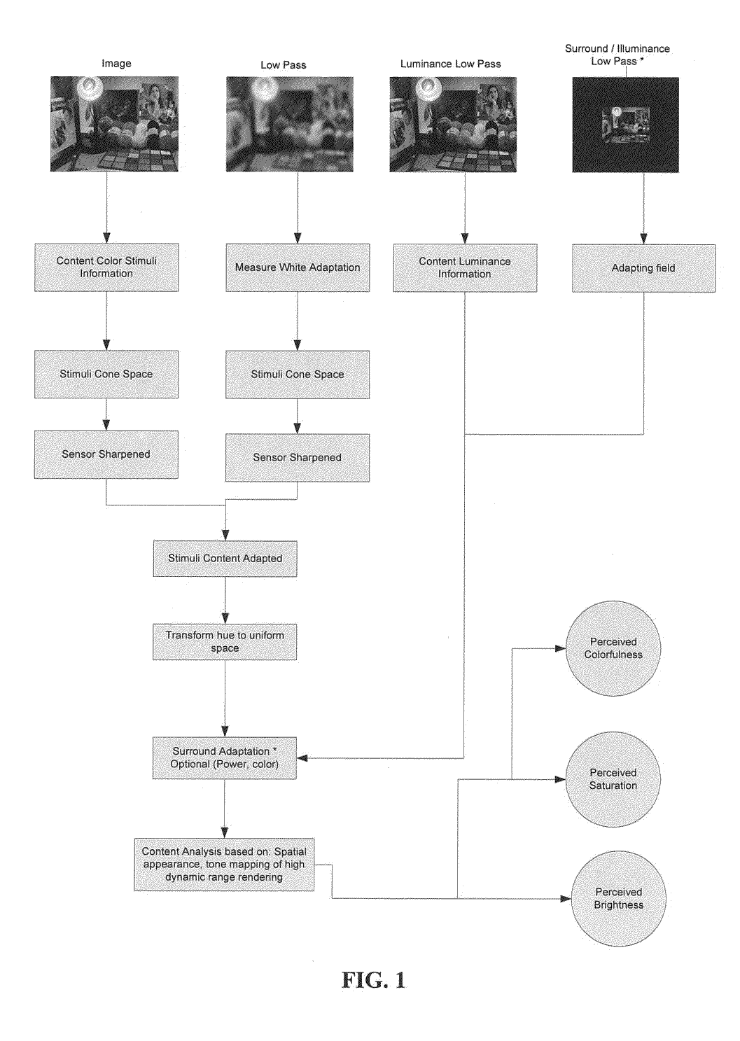

FIG. 2 is a flow diagram of a method of adjusting image content of an image to be displayed according to an embodiment of the present invention.

FIG. 3 is a flow diagram of a process for creating a look-up table according to an embodiment of the present invention.

FIG. 4 is a diagram of a system for adjusting image content of an image to be displayed according to an embodiment of the present invention.

### DETAILED DESCRIPTION

An aspect of embodiments of the present invention relates to a content-aware image adjustment system and process that improve preservation of image features (e.g., important image features) and colors while not exceeding a display's threshold (e.g., a power or current threshold).

According to another aspect of embodiments of the present invention, an image adjustment system and process for reducing current load on an OLED display consider the appearance of each pixel while making adjustments to the image content. In one embodiment, the system and process check whether the input image should be adjusted and calculate parameters for the adjustment.

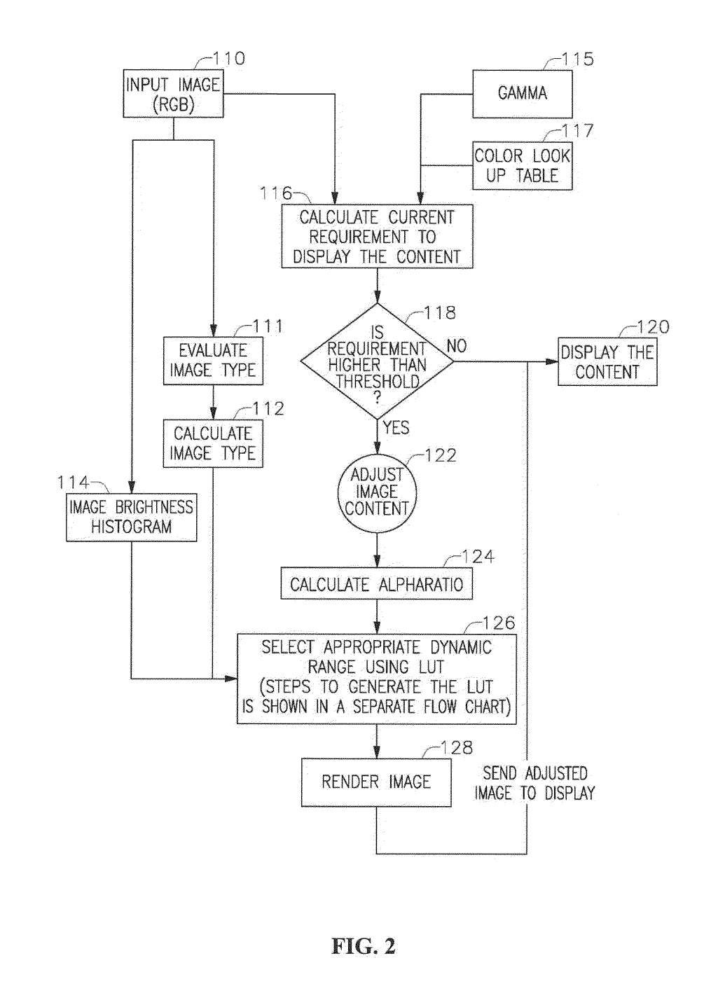

FIG. 2 is a flow diagram of a method of adjusting image content of an image to be displayed according to an embodiment of the present invention. In FIG. 2, an image (e.g., an RGB image) is input to a display system at box 110. The image is evaluated at boxes 111, 112, and 114. At box 111, the image is evaluated by determining an image type of the image. For example, the image type may be scenes or computer-generated graphs. At box 112, the image type is calculated. Additionally, at box 114, an image brightness histogram corresponding to the image is created. In one embodiment, the image brightness histogram plots the number of pixels in the image on one axis and brightness values for the pixels on another axis.

At box 116, a current load amount (e.g., current requirement) for displaying the input image is calculated utilizing the information at boxes 115 and 117. For example, as shown in FIG. 2, a current load amount for displaying the image content of the input image is calculated at box 116 utilizing (or based on) a gamma value of the image at box 115 and a color look up table at box 117. The gamma value may be an encoded gamma value for the input image. The color look up table may be utilized to index for appropriate coverage of a color.

At box 118, the current load amount calculated at box 116 is compared with a system threshold level (e.g., a current threshold) of the display to determine whether or not the current load amount calculated at box 116 exceeds (or is higher than) the system threshold level of the display. The image content of the image is either adjusted or not adjusted in response to the comparison at box 118. When the current load amount for displaying the input image does not exceed the system threshold level of the display, the image content of the input image is displayed at box 120. On the other hand, when the current load amount (or current level) for displaying the input image exceeds the system threshold (e.g., the current threshold) of the display, an adjustment process for adjusting the image content is performed at boxes 122, 124, and 126, and the adjusted image is rendered at box 128 and displayed at box 120.

In one embodiment, for an input image (or input image frame) that is determined at box 118 to be adjusted, the image content of the image is adjusted by selecting a dynamic range for rendering the image content. A rendering pipeline renders the image content in a smaller dynamic range based on the selected range, which reduces the amount of current utilized to display the image content. As shown in FIG. 2, a dynamic range (e.g., an appropriate or suitable dynamic range) may be selected at box 126 based on the image type (or image content type) determined at boxes 111 and 112, the image brightness level determined at box 114, and an AlphaRatio calculated at box 124.

According to an embodiment, the AlphaRatio is a ratio of the current threshold to the current load amount. The AlphaRatio is calculated at box 124 based on Equation (1). In Equation (1), the system threshold level (e.g., CurrentThreshold) is divided by the current load amount to display the input image (e.g., ImageRequiredTotalCurrent). The CurrentThreshold may vary depending on the display, and the ImageRequiredTotalCurrent may be the load current amount calculated at box 116.

$$AlphaRatio = \frac{CurrentThreshold}{ImageRequiredTotalCurrent} \qquad ( 1 )$$

The image type (or image content type) determined at boxes 111 and 112, the image brightness level determined at box 114, and the AlphaRatio calculated at box 124 are input to box 126 so that a dynamic range (e.g., a smaller dynamic range) can be selected for rendering the image content. That is, the reduction (e.g., suitable or appropriate reduction) in tone rendering range may vary based on the image content and brightness level.

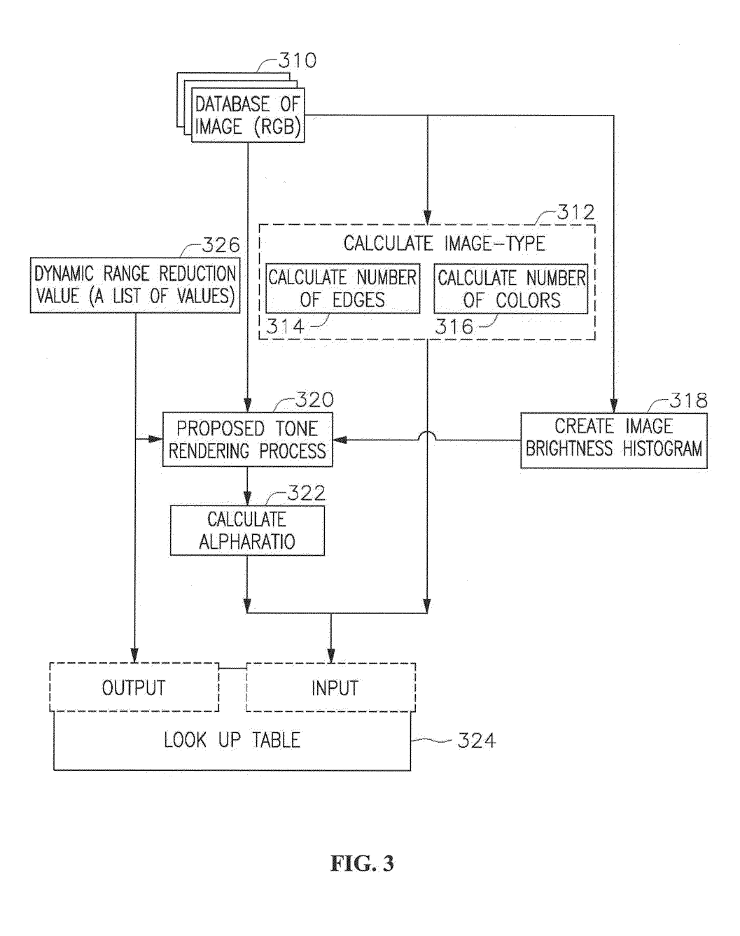

At box 126, a dynamic range (e.g., an appropriate dynamic range) for rendering the image content is selected using a look up table (LUT). According to one embodiment, the LUT is utilized to select a rendering range for improved preservation and accuracy of image content and colors. The LUT may be indexed by at least one of the following parameters: AlphaRatio, an image type of the image, and/or image brightness information of the image. The LUT reduces the iterative process by providing a faster way to determine a corresponding (or appropriate) dynamic range for rending the image content, based on the particular attributes of the image to be displayed. A process for generating the LUT utilized at box 126 will be shown and described with respect to FIG. 3. At box 128, the image is rendered in a rendering pipeline according to the dynamic range selected at box 126. In one embodiment, the image content is rendered according to a high dynamic tone reproduction process. The adjusted image is displayed at box 120.

FIG. 3 is a flow diagram of a process for creating a look-up table according to an embodiment of the present invention. In one embodiment, a training process (or training step) is utilized to create the LUT based on training of images (or image frames) in a database. The LUT is utilized by the process in FIG. 2 to select a dynamic rendering range (e.g., an appropriate dynamic rendering range).

A database of images (e.g., RGB images) as indicated at box 310 may include a plurality of (or a collection of) sample images (e.g., a random assortment of images) for training purposes to create the LUT. The images (or image training sets) may be selected and refined until the corresponding dynamic ranges (or predictions) have a suitable accuracy.

At box 312, a parameter for the LUT, Image-Type, is calculated for each image in the database by considering the number of edges (e.g., distinct edges) at box 314 and the number of colors (e.g., distinct colors) at box 316 in the image (or image frame). The number of edges (e.g., distinct edges) may be calculated using bilateral filters that are adapted to each color channel. In addition, a color histogram with a number of bins (e.g., a limited number of bins), for example, 15 bins, may be utilized to calculate the range of colors (e.g., distinct colors) in the image content of each image (or image frame). In one embodiment, the two factors, number of edges and number of colors, are utilized to calculate a score for the Image-Type parameter. For example, a weighted addition of the two factors may provide a score for the Image-Type parameter. The weights on the addition may be adjusted depending on the system use mode, such as whether the display is primarily utilized for viewing office documents or for viewing scene images. The Image-Type parameter values for the images of the database calculated at box 312 are entered into the LUT as inputs at box 324.

An image brightness histogram may be generated at box 318 for each image in the database. In one embodiment, the image brightness histogram plots the number of pixels in the image on one axis and brightness values for the pixels on another axis. Information from the image brightness histogram created at box 318 is utilized as part of the tone rendering process at box 320.

At box 320, each image in the database of images is subjected to a tone rendering process, utilizing the image brightness information from box 318 and a list of dynamic range reduction values from box 326. The AlphaRatio calculated at box 322 for each image is entered into the LUT as inputs at box 324. As such, inputs to the LUT for each sample image include image type information of the sample image and a ratio of the current threshold to a current load amount for displaying the sample image. The list of dynamic range reduction values at box 326 is entered into the LUT at box 324 as outputs corresponding to the inputs. Thus, the Image-Type and

AlphaRatio inputs of the LUT may be utilized to determine the proper amount of dynamic range reduction utilized in the tone mapping for compressing the image content. According to an embodiment, the LUT at box 324 of FIG. 3 is utilized to select a dynamic range (e.g., an appropriate dynamic range) at box 126 of FIG. 2.

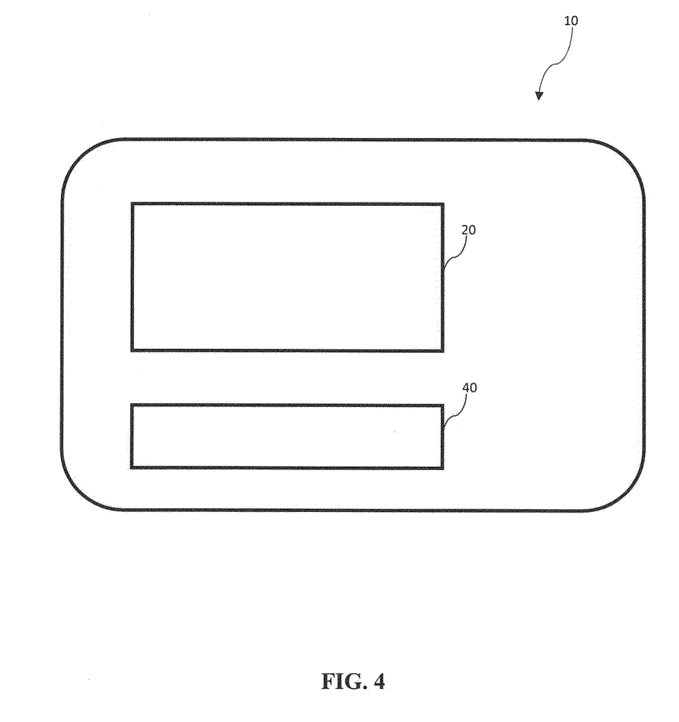

FIG. 4 is a diagram of a system for adjusting image content of an image to be displayed according to an embodiment of the present invention. A display system 10 includes a processor 20 and a memory 40. In some embodiments, the processor 20 may be a plurality of processors. The memory 40 may store instructions for execution by the processor 20. In one embodiment, the instructions stored in memory 40, when executed, cause the processor 20 to perform the processes described above with respect to FIGS. 2 and 3.

When the dynamic range of the input image is adjusted by being reduced, the current load amount for displaying the image content is also reduced and thus avoids exceeding the system threshold of the display. In addition, an image adjustment process for reducing current load on an OLED display according to embodiments of the present invention improves the rendering pipeline by considering the appearance of pixels in the input image in relation to other pixels, rather than treating each pixel independently. Accordingly, a method of adjusting image content according to embodiments of the present invention preserves the perceived dynamic range of the image while maintaining (or prioritizing) more accurate reproduction of color and image features.

A method of adjusting image content according to some embodiments adjusts fixed (or static) image content. However, embodiments of the present invention are not limited thereto, and may be extended to other types of image content such as movies or other dynamic content. In the case of dynamic content, the method shown in FIG. 2 may be applied to each image frame of the content.

Also, additional parameters may be utilized in the LUT, such as types of edges. In addition, different LUTs may be utilized for different image types.

While the present invention has been particularly shown and described with reference to example embodiments thereof, it will be understood by those of ordinary skill in the art that various changes in form and details may be made therein without departing from the spirit and scope of the present invention as defined by the following claims and their equivalents.

What is claimed is:

1. A system for adjusting image content of an image to be displayed, comprising:
a processor; and
a memory, wherein the memory stores instructions that, when executed by the processor, cause the processor to:
evaluate the image;
calculate a current load amount for displaying the image;
compare the current load amount with a current threshold of the system; and
adjust or not adjust the image content of the image in response to the comparison, wherein the image content is adjusted by selecting a dynamic range for rendering the image content.

2. The system of claim 1, wherein the image content is adjusted when the current load amount exceeds the current threshold.

3. The system of claim 1, wherein the image is evaluated by determining an image type of the image.

4. The system of claim 1, wherein the instructions, when executed, further cause the processor to create an image brightness histogram corresponding to the image.

5. The system of claim 1, wherein the current load amount is calculated utilizing a gamma value of the image and a color lookup table.

6. The system of claim 1, wherein the dynamic range for rendering the image content is selected from a lookup table.

7. The system of claim 6, wherein the lookup table is indexed by at least one of a ratio of the current threshold to the current load amount, an image type of the image, or image brightness information of the image.

8. The system of claim 6, wherein the lookup table is generated utilizing a database comprising a plurality of sample images.

9. The system of claim 8, wherein inputs to the lookup table for each sample image comprise image type information of the sample image and a ratio of the current threshold to a current load amount for displaying the sample image.

10. A method of adjusting image content of an image to be displayed on a display system, the method comprising:
evaluating, by one or more processors, the image;
calculating, by the one or more processors, a current load amount for displaying the image;
comparing, by the one or more processors, the current load amount with a current threshold of the display system; and
adjusting or not adjusting, by the one or more processors, the image content of the image in response to the comparison, wherein the image content is adjusted by selecting a dynamic range for rendering the image content.

11. The method of claim 10, wherein the image content is adjusted when the current load amount exceeds the current threshold.

12. The method of claim 10, wherein the evaluating the image comprises determining an image type of the image.

13. The method of claim 10, further comprising creating, by the one or more processors, an image brightness histogram corresponding to the image.

14. The method of claim 10, wherein the calculating the current load amount comprises utilizing a gamma value of the image and a color lookup table.

15. The method of claim 10, wherein the adjusting the image content comprises selecting the dynamic range for rendering the image content from a lookup table.

16. The method of claim 15, wherein the lookup table is indexed by at least one of a ratio of the current threshold to the current load amount, an image type of the image, or image brightness information of the image.

17. The method of claim 15, wherein the lookup table is generated utilizing a database comprising a plurality of sample images.

18. The method of claim 17, wherein inputs to the lookup table for each sample image comprise image type information of the sample image and a ratio of the current threshold to a current load amount for displaying the sample image.
